(19) United States
(12) Patent Application Publication
(10) Pub. No.: US 2022/0154508 A1
(43) Pub. Date: May 19, 2022

(54) LID OPENING AND CLOSING DEVICE

(71) Applicant: U-Shin Ltd., Nagano (JP)

(72) Inventors: Munehiro Yoshimoto, Hiroshima (JP); Naoya Kuwahara, Hiroshima (JP)

(21) Appl. No.: 17/454,515

(22) Filed: Nov. 11, 2021

(30) Foreign Application Priority Data
Nov. 17, 2020 (JP) 2020-190609

(51) Int. Cl. E05F 1/08; E05B 83/34; B60K 15/05

(52) U.S. Cl. CPC E05F 1/08; E05B 83/34; E05Y 2900/534; B60K 2015/0561; B60K 2015/0515; B60K 15/05

(57) ABSTRACT

To improve the operability of the pushrod, in the lid opening and closing device, the sleeve supports the pushrod, and the cam protrusion of the pushrod is inserted into the cam hole of the sleeve so as to be relatively movable. When the pushrod reciprocates in the axial direction, the cam hole guides the cam protrusion, and the pushrod rotates. The sleeve has a small-diameter tubular portion, a large-diameter tubular portion, and a connecting portion that connects them. These two tubular portions are separated in the axial direction, and the cam hole is arranged between them. That is, the sleeve is composed of a single member. Thus, compared with the case where the sleeve is composed of two members, small-diameter and large-diameter tubular portion, that are assembled to the case, it is possible to suppress the displacement of both end faces in the width direction of the cam hole.

### CROSS-REFERENCE TO RELATED APPLICATIONS

This application claims the benefit of Japanese Application No. 2020-190609, filed Nov. 17, 2020, the entire disclosure of which is hereby incorporated herein by reference.

### BACKGROUND OF THE INVENTION

### Field of the Invention

The present invention relates to a lid opening and closing device.

### Description of the Related Art

In the lid opening and closing device described in Patent Document 1 below, the fuel lid is opened and closed by a so-called push-push mechanism. This push-push mechanism holds the moving member (pushrod) at the pushing position and closes the fuel lid by pushing the fuel lid in the closing direction, and the fuel lid is opened by pushing the fuel lid again and projecting the moving member.

### PRIOR ART DOCUMENT

Further, a protrusion is formed in the moving member, and the protrusion is inserted into a guide groove (cam hole) of the main body so as to be relatively movable. As a result, when the moving member moves in the axial direction, the protrusion is guided by the guide groove, and the moving member moves in the axial direction while rotating.

[Patent Document 1]

International Publication No. 2018/038034.

### SUMMARY OF INVENTION

### Problems to be Solved by the Invention

However, the lid opening and closing device has room for improvement in the following points. That is, in the lid opening and closing device, the cylindrical main body is composed of two members, a first main body and a second main body, which are divided into two in the axial direction, and a guide groove is formed between the first main body and the second main body. Therefore, for example, when the first main body and the second main body are assembled so as to be displaced in the circumferential direction of the main body, the shape of the guide groove is formed to be different from the normal shape. In this case, for example, the protrusion may move in the cam groove in the opposite direction. This may reduce the operating performance of the moving member.

It is an object of the present invention to provide a lid opening and closing device capable of improving the operability of a pushrod in consideration of the above facts.

### Means to Solve Problems

At least one embodiment of the present invention is a lid opening and closing device comprising: a pushrod configured to be able to make a reciprocating movement in the axial direction and has a protrusion on the outer circumference; a tubular sleeve that accommodates the pushrod so that it can be moved in the axial direction and rotatable around the axis; wherein, the sleeve comprises: a first sleeve configuring the one side portion in the axial direction of the sleeve; a second sleeve that is arranged apart on the other side in the axial direction of the first sleeve and configuring the other side portion in the axial direction of the sleeve; a connecting portion that connects the first sleeve and the second sleeve; a cam hole that is arranged between the first sleeve and the second sleeve and into which the protrusion is inserted so as to be relatively movable, and guides the protrusion and rotates the pushrod to one side in the rotation direction during the reciprocating movement of the pushrod in the axial direction, wherein the first sleeve and the second sleeve are arranged at positions where they do not overlap when viewed from the axial direction of the sleeve.

At least one embodiment of the present invention is the lid opening and closing device, wherein the connecting portion comprises: a connecting main body portion extending in the axial direction on the outer side in the radial direction of the first sleeve and the second sleeve; a first leg portion that connects one end of the connecting main body portion and the first sleeve; and a second leg portion that connects the other end of the connecting main body portion and the second sleeve.

At least one embodiment of the present invention is the lid opening and closing device, wherein the second sleeve is formed with an insertion groove configured so that the protrusion can be inserted, wherein the insertion groove penetrates the second sleeve in the axial direction and communicates with the cam hole.

At least one embodiment of the present invention is the lid opening and closing device, wherein the pushrod is urged to one side in the axial direction by an urging member, the cam hole comprises a first cam hole portion that guides the protrusion when the pushrod moves to the other side in the axial direction, and a second cam hole portion that guides the protrusion when the pushrod moves to one side in the axial direction, wherein the second cam hole portion communicates with the insertion groove.

At least one embodiment of the present invention is the lid opening and closing device, wherein the diameter of the first sleeve is set smaller than the diameter of the second sleeve, the insertion groove penetrates the connecting main body portion in the radial direction of the sleeve, and the first leg portion and the insertion groove are arranged so as to overlap each other, when viewed from the axial direction of the sleeve.

### Effects of the Invention

According to one or more embodiments of the present invention, the operability of the pushrod can be improved.

### BRIEF DESCRIPTION OF DRAWINGS

FIG. 1 is a perspective view which shows the lid opening and closing device which concerns on this embodiment.

FIG. 2 is an exploded perspective view of the lid opening and closing device shown in FIG. 1.

FIG. 3 is a plan view which shows the lid opening and closing device shown in FIG. 1 in a state where the upper case is removed.

FIG. 4 is a plan view showing a state in which the pushrod of the lid opening and closing device shown in FIG. 3 is pushed into the pushing position.

FIG. 5 is an exploded perspective view of the push-push mechanism shown in FIG. 2.

FIG. 6 is a trihedral figure of the sleeve shown in FIG. 5.

FIG. 7 is a perspective view of the lock member shown in FIG. 2.

FIG. 8A is a front view seen from the front side showing a state in which the pushrod is arranged at the pushing position and the locking member is arranged at the locking position, and FIG. 8B is a front view showing a state in which the pushrod is arranged at the protruding position and the lock member is arranged at the unlocked position.

FIG. 9 is a cross-sectional view (enlarged cross-sectional view taken along line 9-9 of FIG. 8A) showing an engaged state between the cam protrusion and the lock portion shown in FIG. 8A.

FIG. 10 is a developed view of the cam hole of the sleeve shown in FIG. 5.

### EMBODIMENTS OF THE INVENTION

Hereinafter, the lid opening and closing device 10 according to the present embodiment will be described with reference to the drawings. The arrows UP, FR, and RH, which are appropriately shown in the drawings, indicate the upper side, the front side, and the right side of the lid opening and closing device 10, respectively. In the following description, the vertical, front-back, and left-right directions of the lid opening and closing device 10 are used to indicate the up-down direction, front-back direction, and left-right direction of the lid opening and closing device 10 unless otherwise specified.

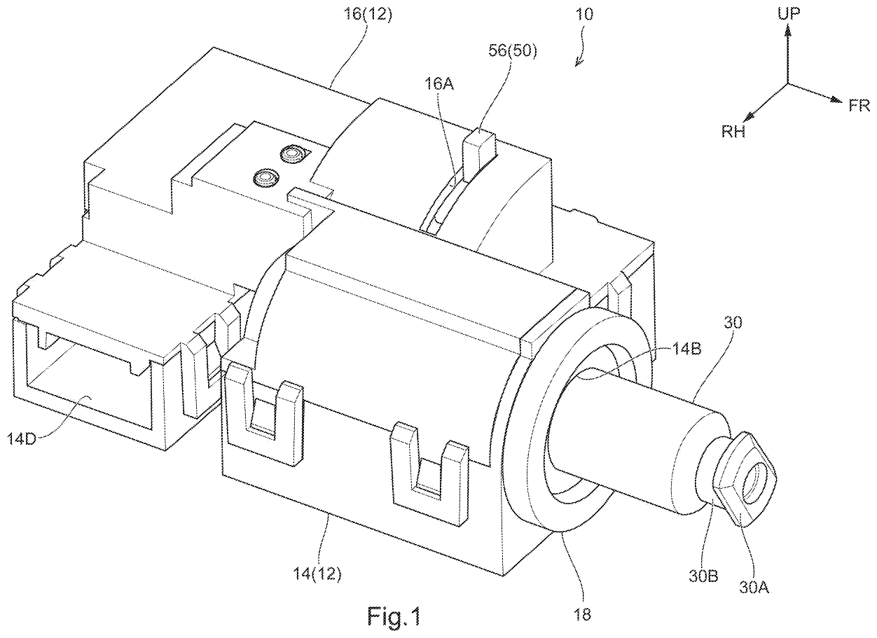

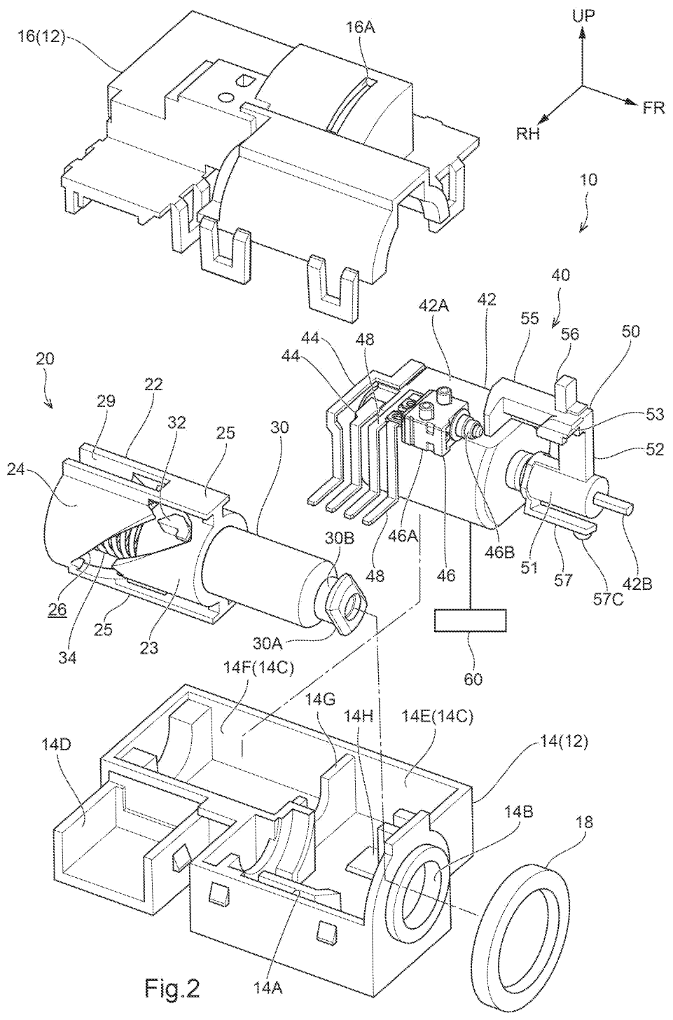

As shown in FIGS. 1 and 2, the lid opening and closing device 10 is configured as an opening and closing device for a fuel lid (not shown) that opens and closes a fuel filler port of a vehicle (automobile). The lid opening and closing device 10 comprises a case 12 that form an outer shell of the lid opening and closing device 10, a push-push mechanism 20, and a lock mechanism 40.

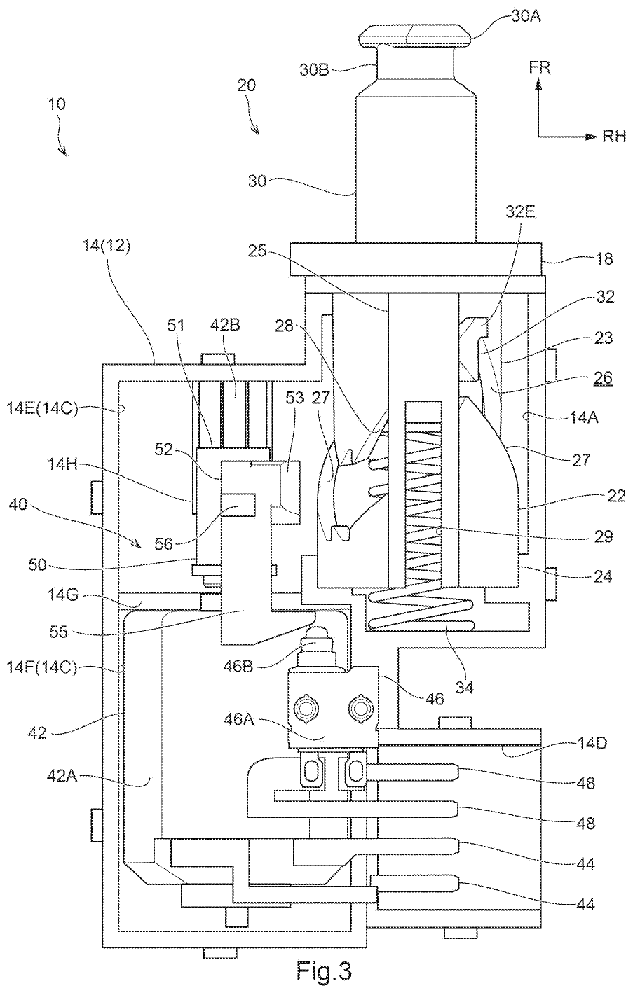

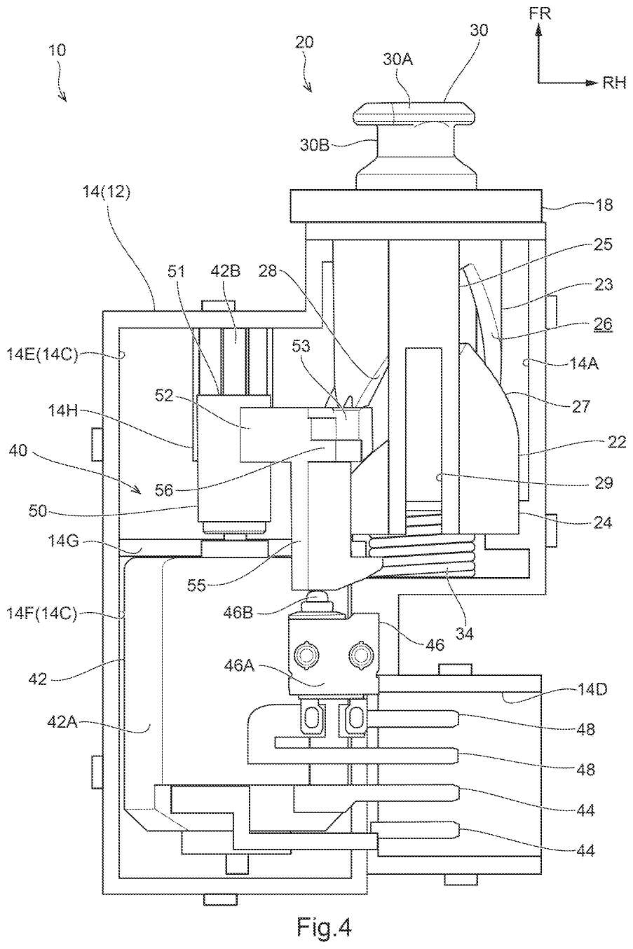

Further, as will be described in detail later, the push-push mechanism 20 has a pushrod 30 whose axial direction is the front-rear direction, and the pushrod 30 is configured to be movable (can move forward and backward) between the protruding position shown in FIG. 3 and the pushing position pushed backward from the protruding position (cf. FIG. 4). By arranging the pushrod 30 at the protruding position, the fuel lid is set to be in an open state in which the fuel filler port is opened. On the other hand, when the fuel lid is in the closed state with the fuel filler port closed, the pushrod 30 is pushed from the protruding position to the pushing position by the fuel lid, and the lid opening and closing device 10 maintains the closed state of the fuel lid. Hereinafter, each configuration of the lid opening and closing device 10 will be described.

### (Case 12)

As shown in FIGS. 1 to 4, the case 12 is formed in a roughly U-shaped box shape that is open to the right side in a plan view seen from above. The case 12 is divided into two in the vertical direction. Specifically, the case 12 comprises a lower case 14 that constitutes a lower portion of the case 12 and an upper case 16 that constitutes an upper portion of the case 12.

The lower case 14 is formed in a box shape that is open upward. The front portion of the right portion of the lower case 14 is configured as a first accommodating portion 14A for accommodating the push-push mechanism 20 described later. A circular insertion hole 14B is formed through the front wall of the first accommodating portion 14A. Further, the opening edge portion on the front side of the insertion hole 14B protrudes to the front side, and a cylindrical pad 18 is fitted in the opening edge portion.

The left portion of the lower case 14 is configured as a second accommodating portion 14C for accommodating the lock mechanism 40 described later. A connector portion 14D projecting to the right side is formed at the rear end portion of the second accommodating portion 14C, and the connector portion 14D is arranged on the rear side of the first accommodating portion 14A and is opened to the right side. The front portion of the second accommodating portion 14C is configured as the lock member accommodating portion 14E, the rear portion of the second accommodating portion 14C is configured as a motor accommodating portion 14F, and the lock member accommodating portion 14E and the motor accommodating portion 14F are partitioned by a partition wall 14G. A raised portion 14H that rises upward is formed on the front portion of the bottom surface of the lock member accommodating portion 14E, and the lock member 50, which will be described later, is held by the raised portion 14H (cf. FIGS. 3, 4, and 8).

The upper case 16 is formed in a plate shape with the vertical direction as the plate thickness direction, and formed so that the outer shape of the upper case 16 is similar to the outer shape of the lower case 14 in a plan view. The upper case 16 is assembled to the lower case 14 by claw fitting to close the opening of the lower case 14. Further, a part of the upper case 16 is raised upward corresponding to the push-push mechanism 20 and the lock mechanism 40, which will be described later.

### (Push-Push Mechanism 20)

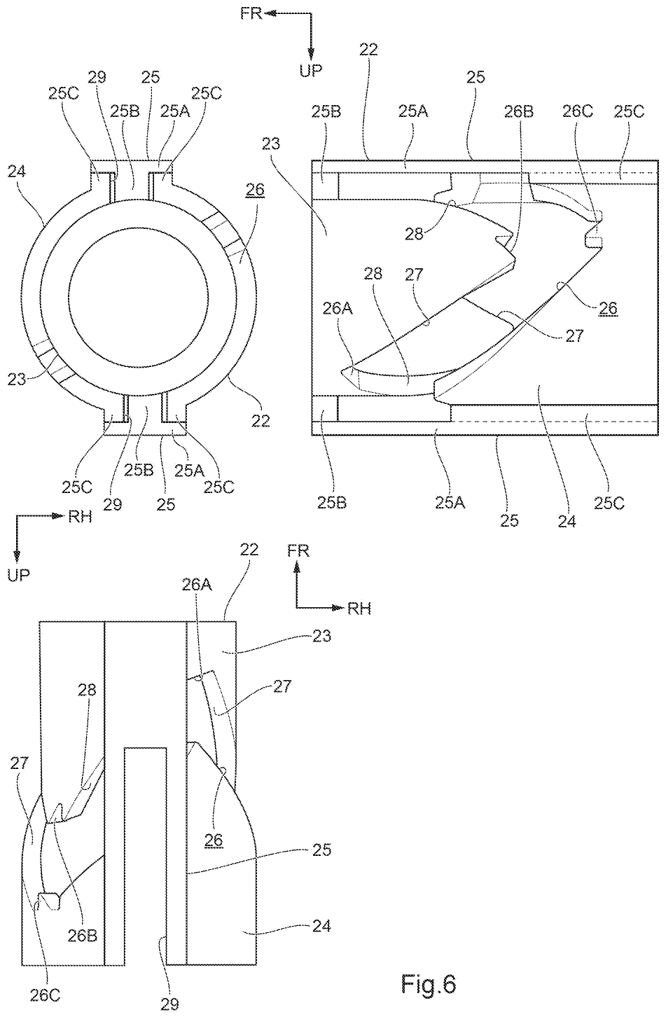

As shown in FIGS. 2 to 6, the push-push mechanism 20 includes a sleeve 22, a pushrod 30, and a spring 34 as an urging member.

### <Sleeve 22>

The sleeve 22 is made of resin and is formed in a roughly cylindrical shape with the front-rear direction as the axial direction as a whole. The sleeve 22 is arranged coaxially with the insertion hole 14B in the first accommodating portion 14A of the case 12, and is fixed to the case 12 by the upper case 16 and the lower case 14. The sleeve 22 comprises a small-diameter tubular portion 23 as the first sleeve constituting the front portion (one side portion in the axial direction) of the sleeve 22, a large-diameter tubular portion 24 as a second sleeve constituting the rear portion (the other side portion in the axial direction) of the sleeve 22, and a pair of connecting portions 25 for connecting the small-diameter tubular portion 23 and the large-diameter tubular portion 24. The small-diameter tubular portion 23 and the large-diameter tubular portion 24 are arranged apart from each other in the front-rear direction. As a result, a cam hole 26 is formed between the small-diameter tubular portion 23 and the large-diameter tubular portion 24 on the outer peripheral wall of the sleeve 22, and the cam hole 26 is formed over the entire circumference of the sleeve 22 in the circumferential direction. The cam hole 26 guides the movement of the pushrod 30, which will be described later.

The diameter of the small-diameter tubular portion 23 is set smaller than the diameter of the large-diameter tubular portion 24, and the small-diameter tubular portion 23 is arranged inside in the radial direction of the large-diameter tubular portion 24 when viewed from the axial direction of the sleeve 22. Specifically, the outer diameter of the small-diameter tubular portion 23 coincides with the inner diameter of the large-diameter tubular portion 24. That is, the small-diameter tubular portion 23 and the large-diameter tubular portion 24 are arranged at positions where they do not overlap when viewed from the axial direction of the sleeve 22.

The pair of connecting portions 25 are arranged on the outer side in the radial direction of the sleeve 22 and are arranged at a distance of approximately 180 degrees in the circumferential direction of the sleeve 22 to connect the small-diameter tubular portion 23 and the large-diameter tubular portion 24. Specifically, one connecting portion 25 projects upward from the small-diameter tubular portion 23 and the large-diameter tubular portion 24, and the other connecting portion 25 projects downward from the small-diameter tubular portion 23 and the large-diameter tubular portion 24. The connecting portion 25 comprises a connecting main body portion 25A, a first leg portion 25B, and a second leg portion 25C.

The connecting main body portion 25A is formed in a roughly long plate shape with the vertical direction as the plate thickness direction and the front-rear direction as the longitudinal direction. The first leg portion 25B protrudes inward in the radial direction of the sleeve 22 from the intermediate portion in the width direction at the front end portion of the connecting main body portion 25A, and is connected to the front end portion of the small-diameter tubular portion 23. The second leg portion 25C protrudes inward in the radial direction of the sleeve 22 from the rear portion of the connecting main body portion 25A and is connected to the outer peripheral portion of the large-diameter tubular portion 24. As a result, the small-diameter tubular portion 23 and the large-diameter tubular portion 24 are connected by the connecting portion 25.

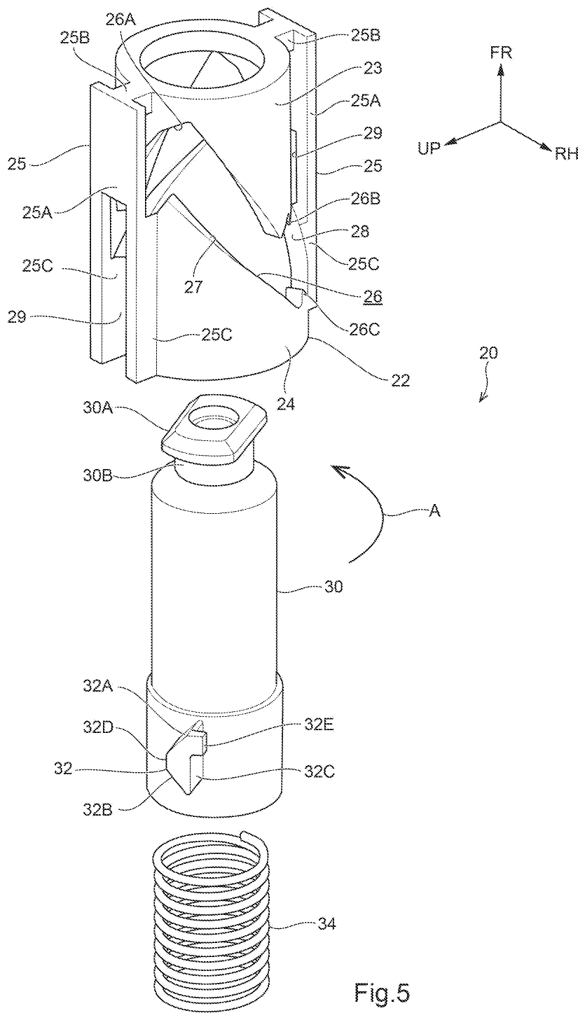

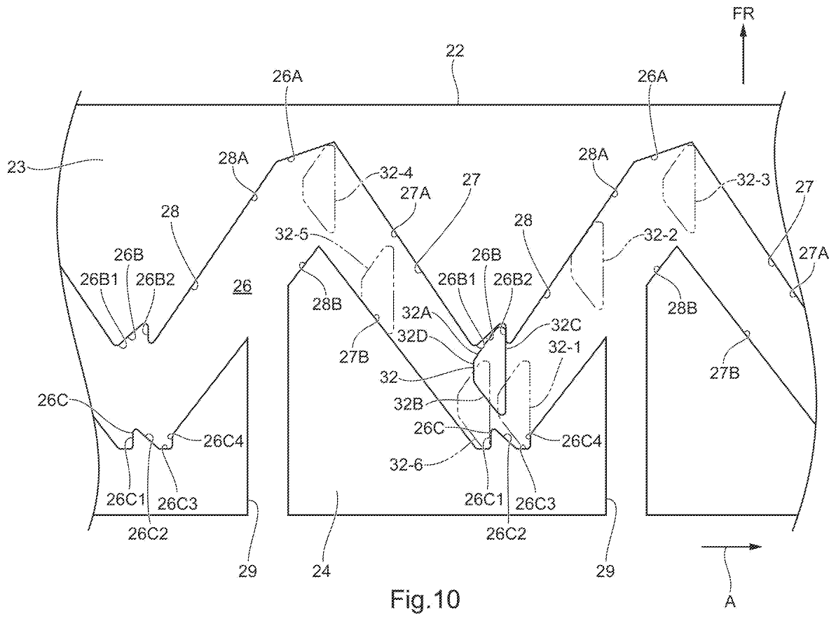

As shown in FIGS. 5 and 10, the cam hole 26 comprises a plurality of (two places in the present embodiment) first cam hole portions 27 and a plurality of (two places in the present embodiment) second cam hole portions 28. The first cam hole portion 27 extends in a direction in which the sleeve 22 is inclined rearward toward one side in the circumferential direction (the side in the direction of arrow A in FIGS. 5 and 10), and the second cam hole portion 28 extends in a direction in which the sleeve 22 is inclined forward toward one side in the circumferential direction. The first cam hole portion 27 and the second cam hole portion 28 are alternately arranged in the circumferential direction of the sleeve 22, and the front ends of the first cam hole portion 27 and the second cam hole portion 28 are connected to each other and the rear ends of the first cam hole portion 27 and the second cam hole portion 28 are connected to each other. Further, the connecting main body portion 25A of the connecting portion 25 described above is arranged on the outside in the radial direction of the sleeve 22 with respect to the second cam hole portion 28.

As shown in FIG. 10, one side surface (front surface) in the width direction of the first cam hole portion 27 is configured as a small-diameter side first cam surface 27A, and the other side surface (rear surface) in the width direction of the first cam hole portion 27 is configured as the large-diameter side first cam surface 27B. Further, one side surface in the width direction of the second cam hole portion 28 is configured as the small-diameter side second cam surface 28A, and the other side surface in the width direction of the second cam hole portion 28 is configured as the large-diameter side second cam surface 28B. As a result, the small-diameter side first cam surface 27A and the small-diameter side second cam surface 28A are formed by the rear end surface of the small-diameter tubular portion 23, and the large-diameter side first cam surface 27B and the large-diameter side second cam surface 28B are formed by the front end surfaces of the large-diameter tubular portion 24.

A first holding portion 26A is formed on the inner peripheral surface of the cam hole 26 on one side in the width direction at the joining portion between the front end portion of the small-diameter side first cam surface 27A and the front end portion of the small-diameter side second cam surface 28A. The first holding portion 26A is inclined to the front side toward one side in the circumferential direction of the sleeve 22 when viewed from the radial direction of the sleeve 22. Further, the inclination angle of the first holding portion 26A with respect to the circumferential direction of the sleeve 22 is set to be smaller than the inclination angle of the small-diameter side second cam surface 28A with respect to the circumferential direction of the sleeve 22. The joining portion between the first holding portion 26A and the small-diameter side first cam surface 27A is arranged on one side in the circumferential direction of the sleeve 22 with respect to the front end portion of the large-diameter side first cam surface 27B. The first holding portion 26A is configured as a holding portion that holds the pushrod 30, which will be described later, at a protruding position.

On the inner peripheral surface of the cam hole 26 on one side in the width direction, a second holding portion 26B is formed at a joining portion between the rear end portion of the small-diameter side first cam surface 27A and the rear end portion of the small-diameter side second cam surface 28A. The second holding portion 26B is formed in a concave shape that is open to the rear side. Specifically, the second holding portion 26B comprises a holding inclined surface 26B1 that is inclined forward toward one side in the circumferential direction of the sleeve 22, and a rotation restricting surface 26B2 extending from the front end of the holding inclined surface 26B1 to the rear side and connected to the rear end of the small-diameter side second cam surface 28A, when viewed from the radial direction of the sleeve 22. The second holding portion 26B is configured as a holding portion that holds the pushrod 30, which will be described later, at the pushing position.

On the inner peripheral surface of the cam hole 26 on the other side in the width direction, a stopper portion 26C is formed at a joining portion between the rear end portion of the large-diameter side first cam surface 27B and the rear end portion of the large-diameter side second cam surface 28B. That is, the second holding portion 26B and the stopper portion 26C are arranged so as to face each other in the front-rear direction. The stopper portion 26C is formed in an uneven shape when viewed from the radial direction of the sleeve 22. Specifically, stopper portion 26C comprises a first stopper surface 26C1 extending from the rear end of the large-diameter side first cam surface 27B to the front side, a stopper inclined surface 26C2 extending from the front end portion of the first stopper surface 26C1 to one side and the rear side in the circumferential direction of the sleeve 22, a horizontal plane 26C3 extending from the rear end of the stopper inclined surface 26C2 to one side in the circumferential direction of the sleeve 22, and a second stopper surface 26C4 extending forward from the tip of the horizontal plane 26C3. In the circumferential direction of the sleeve 22, the first stopper surface 26C1 of the stopper portion 26C is arranged at a position overlapping the intermediate portion in the longitudinal direction of the holding inclined surface 26B1 of the second holding portion 26B. Further, in the circumferential direction of the sleeve 22, the rotation restricting surface 26B2 of the second holding portion 26B is arranged at a position overlapping the intermediate portion in the longitudinal direction of the stopper inclined surface 26C2 of the stopper portion 26C.

As shown in FIGS. 5, 6, and 10, the large-diameter tubular portion 24 is formed with an insertion groove 29 for inserting the cam protrusion 32 of the pushrod 30, which will be described later, at the joining portion with the second leg portion 25C of the connecting portion 25. The insertion groove 29 penetrates the large-diameter tubular portion 24, the connecting main body portion 25A, and the second leg portion 25C in the front-rear direction. Specifically, the insertion groove 29 penetrates the central portion in the width direction of the connecting main body portion 25A, and the second leg portion 25C is divided into two by the insertion groove 29. Further, the front end portion of the insertion groove 29 is arranged at a position overlapping the cam hole 26 (second cam hole portion 28) in the radial direction of the sleeve 22. As a result, the large-diameter tubular portion 24 is formed in a cylindrical shape that is partially opened outward in the radial direction by the insertion groove 29. Further, a part of the second cam hole portion 28 in the cam hole 26 is opened to the rear side by the insertion groove 29, and the large-diameter side second cam surface 28B is divided.

Further, the groove width of the insertion groove 29 is set to be larger than the width dimension of the first leg portion 25B. The first leg portion 25B and the insertion groove 29 overlap each other so that the first leg portion 25B is arranged inside the insertion groove 29 when viewed from the front-rear direction.

### (Pushrod 30)

As shown in FIGS. 1-5, the pushrod 30 is formed in a roughly bottomed cylindrical shape with the front-rear direction as the axial direction and open to the rear side. The pushrod 30 is housed inside the sleeve 22 and is supported by the small-diameter tubular portion 23 so as to be movable in the front-rear direction and rotatable around the axis. Further, the front side portion (one side in the axial direction) of the pushrod 30 is inserted into the insertion hole 14B of the lower case 14, and the front end portion of the pushrod 30 projects from the pad 18 to the front side.

A locking portion 30A is formed at the tip end portion (front end portion) of the pushrod 30, and the locking portion 30A is formed in a roughly track-shaped plate shape with the axial direction of the pushrod 30 as the plate thickness direction. Further, on the outer peripheral portion of the pushrod 30, a constricted portion 30B having a diameter smaller than that of the pushrod 30 is formed on the rear side of the locking portion 30A.

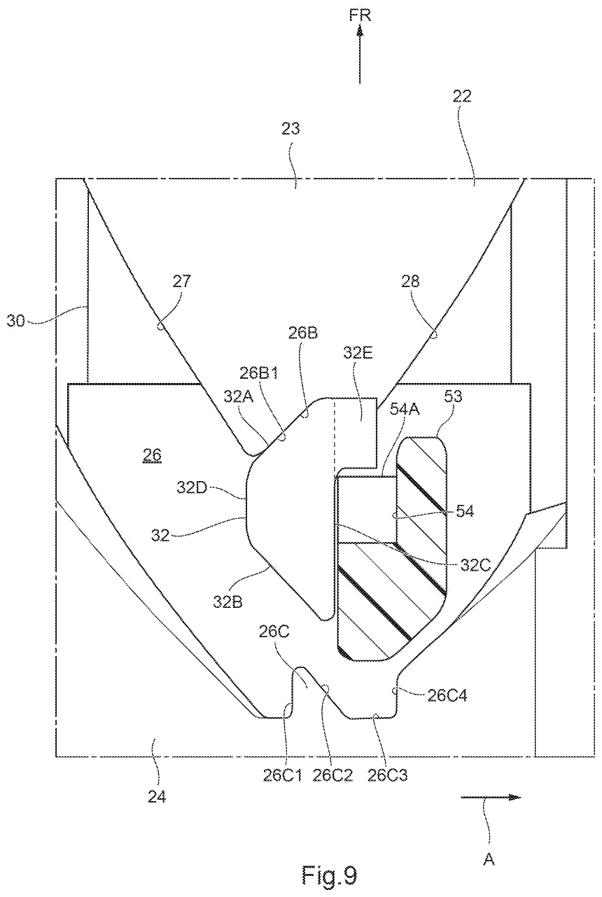

As shown in FIG. 9, a cam protrusions 32 as a plurality of (two places in the present embodiment) protrusions protruding outward in the radial direction are integrally formed on the outer peripheral portion of the rear end portion of the pushrod 30. The pair of cam protrusions 32 are arranged 180 degrees apart in the circumferential direction of the pushrod 30. The cam protrusion 32 is formed in a roughly trapezoidal block shape when viewed from the radial direction of the pushrod 30. Specifically, the cam protrusions 32 comprises a front inclined surface 32A inclined forward toward one side in the rotation direction of the pushrod 30 (the side in the direction of arrow A in FIGS. 5 and 9), a rear inclined surface 32B arranged on the rear side of the front inclined surface 32A and inclined to the rear side toward one side in the rotation direction of the pushrod 30, a first connecting surface 32C that extends in the front-rear direction and connects the front end of the front inclined surface 32A and the rear end of the rear inclined surface 32B, and a second connecting surface 32D extending in the front-rear direction and connecting the rear end portion of the front inclined surface 32A and the front end portion of the rear inclined surface 32B, when viewed from the radial direction of the pushrod 30.

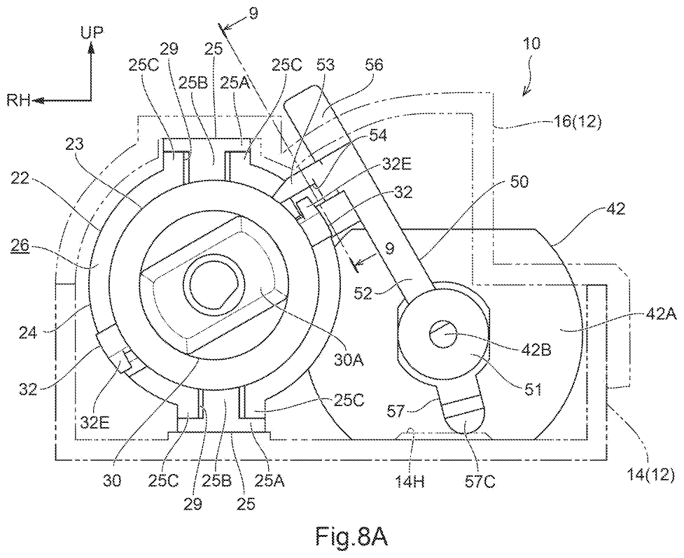

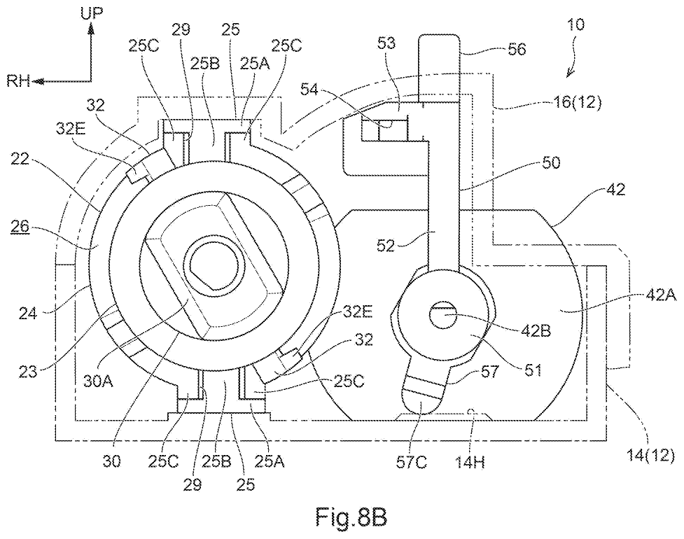

The width dimension of the cam protrusion 32 (the dimension between the first connecting surface 32C and the second connecting surface 32D) is set smaller than the width groove dimension of the insertion groove 29 of the sleeve 22. By inserting the pushrod 30 into the sleeve 22 from the rear side, the cam protrusion 32 is arranged in the cam hole 26 of the sleeve 22 through the insertion groove 29. Further, the cam protrusion 32 is arranged in the cam hole 26 so that the tip surface (radial outer side end face of pushrod 30) of the cam protrusion 32 slightly protrudes outward in the radial direction with respect to the outer peripheral surface of the large-diameter tubular portion 24 when viewed from the front side (cf. FIG. 8).

Further, a rod-side engaging portion 32E is formed at the front end portion of the first connecting surface 32C at the tip end portion of the cam protrusion 32. The rod-side engaging portion 32E is formed in a roughly rectangular block shape, protrudes from the cam protrusion 32 to one side in the rotation direction of the pushrod 30, and is arranged on the outer side in the radial direction of the small-diameter tubular portion 23.

### <Spring 34>

As shown in FIGS. 3-5, the spring 34 is configured as a compression coil spring. The spring 34 is arranged in the rear end of the sleeve 22, wherein the front end of the spring 34 is locked to the rear end of the pushrod 30, and the rear end of the spring 34 is locked to the rear wall of the first accommodating portion 14A in the lower case 14. As a result, the spring 34 urges the pushrod 30 to the front side (one side in the axial direction, also called the protruding direction), and the front end portion (boundary portion between the front inclined surface 32A and the first connecting surface 32C) of the cam protrusion 32 of the pushrod 30 comes into contact with one side surface in the width direction of the cam hole 26. On the other hand, by pressing the pushrod 30 to the rear side (the other side in the axial direction, also called the pushing direction) against the urging force of the spring 34, the rear end portion (boundary portion between the rear inclined surface 32B and the first connecting surface 32C) of the cam protrusion 32 comes into contact with the other side surface in the width direction of the cam hole 26.

Due to the urging force of the spring 34, the cam protrusion 32 is held by the second holding portion 26B of the cam hole 26 at the pushing position of the pushrod 30, and the cam protrusion 32 is held by the first holding portion 26A of the cam hole 26 at the protruding position of the pushrod 30. Further, a fuel lid (not shown) for opening and closing the fuel filler port of the vehicle is provided on the front side of the pushrod 30. When the fuel lid pushes the pushrod 30 into the pushing position so as to close the fuel filler port, the locking portion 30A of the pushrod 30 engages with the fuel lid, and the closed state of the fuel lid is maintained. On the other hand, when the fuel lid is pushed in at the pushing position of the pushrod 30, the pushrod 30 is projected to the protruding position and the closed state of the fuel lid is released.

### (Lock Mechanism 40)

As shown in FIGS. 2-4, the lock mechanism 40 is housed in the second accommodating portion 14C of the lower case 14. The lock mechanism 40 is configured as a mechanism for restricting the movement of the pushrod 30 arranged at the pushing position to the protruding position. The lock mechanism 40 comprises a motor 42, a detection switch 46, and a lock member 50.

### <Motor 42>

The motor 42 is arranged with the front-rear direction as the axial direction, and the motor body 42A of the motor 42 is housed in the motor accommodating portion 14F of the lower case 14 and fixed to the lower case 14 and the upper case 16. That is, the motor body 42A is arranged on the left side and the rear side of the sleeve 22 and the pushrod 30. The output shaft 42B of the motor 42 extends forward from the motor body 42A and is arranged in the lock member accommodating portion 14E of the lower case 14. That is, the output shaft 42B of the motor 42 is arranged in parallel on the left side of the sleeve 22 and the pushrod 30. One end of the pair of motor terminals 44 is connected to the rear end of the motor body 42A, wherein the motor terminal 44 is bent into a predetermined shape, and the other end of the motor terminal 44 is arranged inside the connector portion 14D. The motor terminal 44 is electrically connected to the control unit 60 (cf. FIG. 2), and the motor 42 is driven by the control unit 60.

### <Detection Switch 46>

The detection switch 46 is arranged on the upper side of the motor body 42A and is fixed to the upper case 16. That is, the motor body 42A and the detection switch 46 are arranged at overlapping positions in the front-rear direction and are housed in the second accommodating portion 14C of the case 12. The detection switch 46 is configured as a push-type switch. Specifically, the detection switch 46 comprises a switch main body 46A and a switch portion 46B protruding forward from the switch main body 46A. One end of a pair of switch terminals 48 is connected to the detection switch 46, wherein the switch terminal 48 is bent into a predetermined shape, and the other end of the switch terminal 48 is arranged inside the connector portion 14D. The switch terminal 48 is electrically connected to the control unit 60, and the switch portion 46B is pressed to the rear side to output an on signal to the control unit 60.

### <Lock Member 50>

As shown in FIGS. 2-4, 7, and 8, the lock member 50 comprises a fixing portion 51, a locking portion 53, a switch operating portion 55, a manual operating portion 56, and a lock holding portion 57.

The fixing portion 51 is formed in a roughly cylindrical shape with the front-rear direction as the axial direction. The output shaft 42B of the motor 42 is fitted into the fixed portion 51, and the fixed portion 51 is integrally rotatably fixed to the output shaft 42B. As a result, the lock member 50 rotates between the unlock position (position shown in FIG. 8B) and the lock position (position shown in FIG. 8A) by driving the motor 42. In the following description, it will be described as an unlock position of the lock member 50. Further, a lock arm 52 is integrally formed on the front end side portion of the fixing portion 51, and the lock arm 52 extends upward from the fixing portion 51.

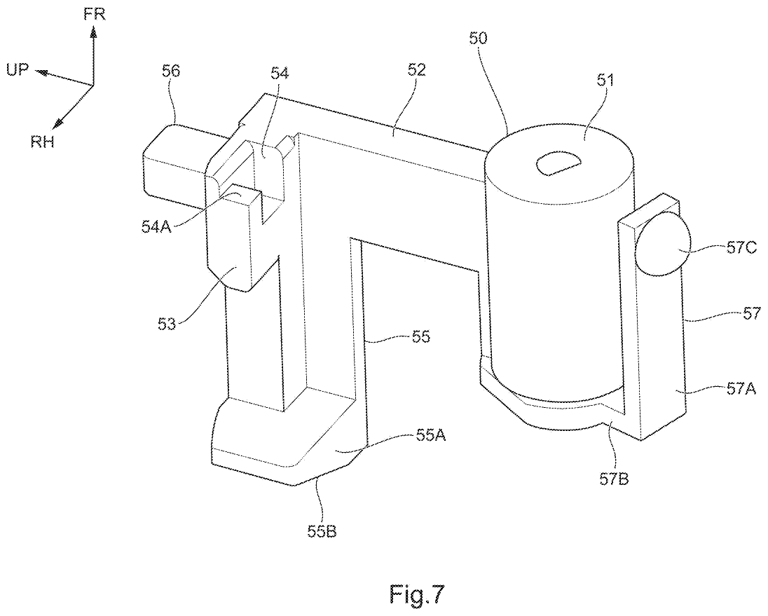

The lock portion 53 is formed at the tip end portion (upper end portion) of the lock arm 52 and is formed in a roughly rectangular block shape protruding to the right from the lock arm 52. An engaging groove 54 (cf. FIG. 7) is formed at the front end of the lock portion 53, and the engaging groove 54 is open to the lower side and the front side. Further, a notch portion 54A (cf. FIG. 7) is formed in the front opening of the engaging groove 54, and the front opening of the engaging groove 54 is opened to the right by the notch portion 54A.

As shown in FIGS. 8A and 9, at the lock position of the lock member 50, the tip end of the lock portion 53 is arranged in the cam hole 26 of the sleeve 22, and is arranged adjacent to the cam protrusion 32 of the pushrod 30 at the pushing position on one side in the rotation direction of the pushrod 30. As a result, it is configured that the rotation of the pushrod 30 in the pushing position to one side in the rotation direction is restricted. Further, at the lock position of the lock member 50, the rod-side engaging portion 32E of the cam protrusion 32 is set to be arranged in the engaging groove 54. Therefore, when the pushrod 30 is moved to the rear side, the rod-side engaging portion 32E engages with the engaging groove 54, and the movement of the pushrod 30 to the rear side is restricted.

As shown in FIGS. 3, 4, and 7, the switch operating portion 55 is formed in a columnar shape extending rearward from the tip end portion of the lock arm 52, and the rear end portion of the switch operating portion 55 is bent to the right side. The rear end portion of the switch operating portion 55 is configured as a switch pressing portion 55A. Further, on the rear surface of the switch pressing portion 55A, an inclined surface 55B is formed at the right end portion, wherein the inclined surface 55B is inclined to the front side toward the right side in a plan view. At the unlocked position of the lock member 50, the switch operating unit 55 is arranged on the left side of the detection switch 46 in a state where the switch pressing unit 55A does not press the switch portion 46B of the detection switch 46 (cf. FIG. 3). On the other hand, at the lock position of the lock member 50, the switch portion 46B of the detection switch 46 is set to be pressed to the rear side by the rear surface of the switch operating portion 55.

The manual operating portion 56 is formed in a roughly rectangular columnar shape extending upward from the tip end portion of the lock arm 52. The manual operating portion 56 is inserted through the operation groove 16A formed in the upper case 16, and the tip end portion of the manual operating portion 56 is exposed to the outside of the upper case 16 so that it can be manually operated (cf. FIG. 1).

As shown in FIGS. 2, 7, and 8, the lock holding portion 57 is arranged below the fixing portion 51 and is formed in a roughly L-shaped plate shape when viewed from the left side. Specifically, the lock holding portion 57 comprises a rectangular plate-shaped holding main body 57A extending in the front-rear direction with the vertical direction as the plate thickness direction, and a joining portion 57B protruding upward from the rear end of the holding main body 57A, wherein the joining portion 57B is connected to the fixed portion 51. A contact portion 57C projecting downward is integrally formed at the tip end portion of the holding main body 57A, and the contact portion 57C is formed in a roughly hemispherical shape that is convex downward. Further, the lock holding portion 57 is configured to be elastically deformable in the vertical direction. That is, the lock holding portion 57 is configured as a so-called leaf spring. At either the lock position or the unlock position of the lock member 50, the contact portion 57C abuts on the raised portion 14H of the lower case 14, and the lock holding portion 57 is elastically deformed upward (cf. FIG. 8). As a result, the lock member 50 is held at the lock position and the unlock position.

### (Operation and Effect)

Next, the operation and effect of the present embodiment will be described while explaining the operation of the lid opening and closing device 10 with reference to FIG. 10. In FIG. 10, the cam protrusion 32 of the pushrod 30 arranged at the pushing position is shown by a solid line. Further, the cam protrusion 32 described by the two-dot chain line indicates the cam protrusion 32 corresponding to each operating position of the pushrod 30, and a hyphen is added to the sign of the cam protrusion 32 shown by the two-dot chain line to distinguish it from the cam protrusion 32 shown by the solid line.

(Operation of the Pushrod 30 from the Pushing Position to the Protruding Position)

At the pushing position of the pushrod 30, the fuel lid is in a closed state in which the fuel filler port of the vehicle is closed, and the locking portion 30A of the pushrod 30 is engaged with the fuel lid to maintain the closed state of the fuel lid. Further, in this state, the front end portion of the cam protrusion 32 of the pushrod 30 is arranged in the second holding portion 26B of the sleeve 22, and the pushrod 30 is held at the pushing position. Specifically, the front end portion of the cam protrusion 32 comes into contact with the holding inclined surface 26B1 of the second holding portion 26B, and the movement of the pushrod 30 to the front side is restricted, and the movement of the pushrod 30 to the front side is restricted, and the first connecting surface 32C of the cam protrusion 32 abuts on the rotation restricting surface 26B2 of the second holding portion 26B, and the rotation of the pushrod 30 in one direction in the rotation direction is restricted. Further, in this state, the lock member 50 is arranged at the lock position, and the lock portion 53 of the lock member 50 and the cam protrusion 32 of the pushrod 30 are engaged with each other (cf. FIGS. 8A and 9). As a result, the movement of the pushrod 30 in the pushing direction is restricted by the lock member 50.

In this state, the control unit 60 drives the motor 42 to rotate the lock member 50 from the locked position to the unlocked position (cf. FIG. 8B). As a result, the lock portion 53 of the lock member 50 and the cam protrusion 32 of the pushrod 30 are released from the engaged state, and the pushrod 30 is allowed to move in the pushing direction.

When the fuel lid is pushed in the pushing direction after the lock member 50 is rotated to the unlocked position, the pushrod 30 is pushed to the rear side via the fuel lid. As a result, the cam protrusion 32 of the pushrod 30 is displaced to the rear side, and the rear end portion of the cam protrusion 32 comes into contact with the stopper inclined surface 26C2 of the sleeve 22. When the pushrod 30 is further pushed in, the rear end portion of the cam protrusion 32 slides on the stopper inclined surface 26C2 and the horizontal plane 26C3 of the sleeve 22, and the pushrod 30 rotates to one side in the rotation direction. When the cam protrusion 32 reaches the second stopper surface 26C4 of the sleeve 22 and comes into contact with the second stopper surface 26C4, the rotation of the pushrod 30 in one direction in the rotation direction is restricted (cf. the cam protrusion 32-1 indicated by the two-dot chain line in FIG. 10).

When the cam protrusion 32 reaches the second stopper surface 26C4, the front end portion of the cam protrusion 32 is arranged on the rear side of the small-diameter side second cam surface 28A of the second cam hole portion 28. Therefore, when the push against the fuel lid is released in this state, the pushrod 30 moves to the front side by the urging force of the spring 34, and the front end portion of the cam protrusion 32 comes into contact with the small-diameter side second cam surface 28A. The cam protrusion 32 moves from the rear end to the front end of the second cam hole portion 28 while the front end of the cam protrusion 32 slides on the small-diameter side second cam surface 28A (cf. cam protrusion 32-2 shown by the two-dot chain line in FIG. 10). As a result, the pushrod 30 moves to the protruding direction side while rotating to one side in the rotation direction. Therefore, the engagement state between the locking portion 30A of the pushrod 30 and the fuel lid is released, and the fuel lid is pressed forward by the pushrod 30 to open the fuel filler port of the vehicle.

When the pushrod 30 reaches the protruding position, the front end portion of the cam protrusion 32 comes into contact with the first holding portion 26A of the sleeve 22, and the movement of the pushrod 30 in the protruding direction is restricted. As a result, the pushrod 30 is held in the protruding position (cf. cam protrusion 32-3 indicated by the two-dot chain line in FIG. 10).

(Operation of the Pushrod 30 from the Protruding Position to the Pushing Position)

When the fuel lid is open, the pushrod 30 is arranged at the protruding position, and the front end portion of the cam protrusion 32 is in contact with the first holding portion 26A of the cam hole 26 (cf. the cam protrusion 32-4 indicated by the two-dot chain line in FIG. 10). When the fuel lid is closed in this state, the fuel lid pushes the front end portion of the pushrod 30 to the rear side. As a result, the pushrod 30 is displaced rearward from the protruding position against the urging force of the spring 34, and the rear end portion of the cam protrusion 32 comes into contact with the large-diameter side first cam surface 27B of the first cam hole portion 27 in the cam hole 26. When the pushrod 30 is further pushed in the pushing direction by the fuel lid, the cam protrusion 32 moves from the front end to the rear end of the first cam hole portion 27 while the rear end of the cam protrusion 32 slides on the large-diameter side first cam surface 27B (cf. cam protrusion 32-5 shown by the two-dot chain line in FIG. 10). As a result, the pushrod 30 moves in the pushing direction while rotating to one side in the rotation direction. At this time, the locking portion 30A of the pushrod 30 engages with the fuel lid.

When the cam protrusion 32 reaches the stopper portion 26C of the cam hole 26, the first connecting surface 32C of the cam protrusion 32 abuts on the first stopper surface 26C1 of the stopper portion 26C, and the movement of the cam protrusion 32 to the rear side and the rotation to one side in the rotation direction are restricted (cf. cam protrusion 32-6 indicated by the two-dot chain line in FIG. 10). Further, in this state, the holding inclined surface 26B 1 of the second holding portion 26B in the cam hole 26 is arranged on the front side of the front end portion of the cam protrusion 32. Therefore, when the push-in by the fuel lid is released, the pushrod 30 is displaced forward by the urging force of the spring 34, and the front end portion of the cam protrusion 32 abuts on the holding inclined surface 26B 1 of the second holding portion 26B and slides along the holding inclined surface 26B 1 on the front side and one side in the rotational direction. As a result, the front end portion of the cam protrusion 32 comes into contact with the holding inclined surface 26B 1 of the second holding portion 26B and the movement of the pushrod 30 to the front side is restricted, and the first connecting surface 32C of the cam protrusion 32 comes into contact with the rotation restricting surface 26B2 of the second holding portion 26B and the rotation of the pushrod 30 in one direction in the rotation direction is restricted (cf. the cam protrusion 32 shown by the solid line in FIG. 10).

In this state, the control unit 60 drives the motor 42 to rotate the lock member 50 from the unlocked position to the locked position. As a result, the lock portion 53 of the lock member 50 and the cam protrusion 32 of the pushrod 30 are engaged with each other, and the movement of the pushrod 30 in the pushing direction side and the rotation in one side in the rotation direction are restricted. Therefore, the pushrod 30 is held in the pushing position, and the closed state of the fuel lid is maintained.

As described above, in the lid opening and closing device 10 of the present embodiment, the pushrod 30 of the push-push mechanism 20 is supported by the sleeve 22 so as to be movable in the axial direction and rotatable around the axis. Further, the sleeve 22 has a cam hole 26, and the cam protrusion 32 of the pushrod 30 is inserted into the cam hole 26 so as to be relatively movable. During the reciprocating movement between the pushing position and the protruding position of the pushrod 30, the cam protrusion 32 is guided by the cam hole 26, and the pushrod 30 rotates to one side in the rotation direction.

Here, the sleeve 22 comprises a small-diameter tubular portion 23 constituting the front portion of the sleeve 22, a large-diameter tubular portion 24 constituting the rear portion of the sleeve 22, and a connecting portion 25 that connects the small-diameter tubular portion 23 and the large-diameter tubular portion 24. The small-diameter tubular portion 23 and the large-diameter tubular portion 24 are arranged apart from each other in the axial direction, and the cam hole 26 is arranged between the small-diameter tubular portion 23 and the large-diameter tubular portion 24. That is, the sleeve 22 is configured as a single member. As a result, when compared to the case where the sleeve 22 is composed of two members of a small-diameter tubular portion 23 composing one side surface in the width direction of the cam hole 26 and a large-diameter tubular portion 24 composing the other side surface in the width direction of the cam hole 26, and the small-diameter tubular portion 23 and the large-diameter tubular portion 24 are respectively assembled to the case 12, for example, it is possible to prevent both end surfaces in the width direction of the cam hole 26 from shifting in the circumferential direction of the sleeve 22. As a result, the cam hole 26 that guides the movement of the pushrod 30 can be formed with high accuracy. Therefore, the operability of the pushrod 30 can be improved.

Moreover, the small-diameter tubular portion 23 and the large-diameter tubular portion 24 are arranged at positions where they do not overlap when viewed from the axial direction of the sleeve 22. Specifically, when viewed from the axial direction of the sleeve 22, the small-diameter tubular portion 23 is arranged inside in the radial direction of the large-diameter tubular portion 24, and one side surface in the width direction and the other side surface in the width direction of the cam hole 26 are arranged so as to be offset in the radial direction of the sleeve 22. Thereby, for example, when the sleeve 22 is formed by injection molding, the mold can be pulled out on both sides in the axial direction of the sleeve 22 by setting the secant line of the mold at the portion of the cam hole 26. That is, it is possible to prevent the one side surface in the width direction and the other side surface in the width direction of the cam hole 26 from forming an undercut shape with each other. Therefore, even when the sleeve 22 having the cam hole 26 is configured as a single member, the sleeve 22 can be satisfactorily molded while suppressing the complexity of the mold structure for molding the sleeve 22.

Further, the connecting portion 25 of sleeve 22 comprises a connecting main body portion 25A extending in the front-rear direction, a first leg portion 25B that connects the front end portion of the connecting main body portion 25A and the front end portion of the small-diameter tubular portion 23, and a second leg portion 25C that connects the rear portion of the connecting main body portion 25A and the large-diameter tubular portion 24. As a result, with a simple configuration, the sleeve 22 can be configured as a single member by connecting the small-diameter tubular portion 23 and the large-diameter tubular portion 24 separated in the front-rear direction, and the cam hole 26 can be formed between the small-diameter tubular portion 23 and the large-diameter tubular portion 24.

Further, the large-diameter tubular portion 24 is formed with an insertion groove 29 in which a cam protrusion 32 can be inserted, and the insertion groove 29 penetrates in the front-rear direction and communicates with the cam hole 26. As a result, the cam protrusion 32 can be inserted into the cam hole 26 from the insertion groove 29 by inserting the pushrod 30 into the sleeve 22 from the rear side. Therefore, the assembling property of the pushrod 30 to the sleeve 22 can be improved.

Further, the insertion groove 29 communicates with the second cam hole portion 28 in the cam hole 26. That is, the rear surface (large-diameter side second cam surface 28B) of the second cam hole portion 28 is divided by the insertion groove 29. Further, the pushrod 30 is urged to the front side by the spring 34. As a result, when the pushrod 30 is moved from the pushing position to the protruding position, the cam protrusion 32 comes into contact with the front surface of the second cam hole portion 28 (small-diameter side the second cam surface 28A) and is guided to the second cam hole portion 28, due to the urging force of the spring 34. That is, the insertion groove 29 is formed on the large-diameter side second cam surface 28B that does not guide the cam protrusion 32 when the pushrod 30 is moved to the protruding position. As a result, the insertion groove 29 can be formed in the sleeve 22 without affecting the reciprocating movement of the pushrod 30, and the cam protrusion 32 can be arranged in the cam hole 26 by the insertion groove 29.

Further, the diameter of the small-diameter tubular portion 23 is set to be smaller than the diameter of the large-diameter tubular portion 24, and the first leg portion 25B and the insertion groove 29 are arranged so as to overlap each other when viewed from the axial direction of the sleeve 22. More specifically, when viewed from the front side, the first leg portion 25B is arranged inside the insertion groove 29. Thereby, the insertion groove 29 can prevent the first leg portion 25B from becoming an undercut shape in the axial direction of the sleeve 22, for example. Therefore, the complexity of the mold for molding the sleeve 22 can be further suppressed, and the moldability of the sleeve 22 can be improved.

Even though the diameter of the small-diameter tubular portion 23 configuring the front end portion of the sleeve 22 is set to be smaller than the diameter of the large-diameter tubular portion 24 configuring the rear end portion of the sleeve 22 in the present embodiment, the diameter of the tubular portion configuring the front end portion of the sleeve 22 may be set to be larger than the diameter of the tubular portion configuring the rear end portion of the sleeve 22, and the pushrod 30 may be configured to be supported by the rear end portion of the sleeve 22.

Further, in the present embodiment, in the sleeve 22, even though the insertion groove 29 is formed at the joining portion of the large-diameter tubular portion 24 with the connecting portion 25, the position of the insertion groove 29 is not limited to this. For example, the insertion groove 29 may be formed in the large-diameter tubular portion 24 at a position shifted from the connecting portion 25 in the circumferential direction of the sleeve 22. That is, the insertion groove 29 may be formed only in the large-diameter tubular portion 24.

### REFERENCE SIGNS LIST

10; Lid Opening and closing device
22; Sleeve
23; Small-diameter tubular portion (first sleeve)
24; Large-diameter tubular portion (second sleeve)
25; Connecting portion
25A; Connecting main body portion
25B; First leg portion
25C; Second leg portion
26; Cam hole
27; First cam hole portion
28; Second cam hole portion
29; Insertion groove
30; Pushrod
32; Cam protrusion (protrusion)
34; Spring (urging member)

What is claimed is:

1. A lid opening and closing device comprising:
a pushrod configured to be able to make a reciprocating movement in the axial direction and has a protrusion on the outer circumference;
a tubular sleeve that accommodates the pushrod so that it can be moved in the axial direction and rotatable around the axis;
wherein, the sleeve comprises:
a first sleeve configuring the one side portion in the axial direction of the sleeve;
a second sleeve that is arranged apart on the other side in the axial direction of the first sleeve and configuring the other side portion in the axial direction of the sleeve;
a connecting portion that connects the first sleeve and the second sleeve;
a cam hole that is arranged between the first sleeve and the second sleeve and into which the protrusion is inserted so as to be relatively movable, and guides the protrusion and rotates the pushrod to one side in the rotation direction during the reciprocating movement of the pushrod in the axial direction,
wherein the first sleeve and the second sleeve are arranged at positions where they do not overlap when viewed from the axial direction of the sleeve.

2. The lid opening and closing device according to claim 1, wherein the connecting portion comprises:
a connecting main body portion extending in the axial direction on the outer side in the radial direction of the first sleeve and the second sleeve;
a first leg portion that connects one end of the connecting main body portion and the first sleeve;
a second leg portion that connects the other end of the connecting main body portion and the second sleeve.

3. The lid opening and closing device according to claim 2, wherein;
the second sleeve is formed with an insertion groove configured so that the protrusion can be inserted,
wherein the insertion groove penetrates the second sleeve in the axial direction and communicates with the cam hole.

4. The lid opening and closing device according to claim 3, wherein;
the pushrod is urged to one side in the axial direction by an urging member,
the cam hole comprises a first cam hole portion that guides the protrusion when the pushrod moves to the other side in the axial direction, and a second cam hole portion that guides the protrusion when the pushrod moves to one side in the axial direction,
wherein the second cam hole portion communicates with the insertion groove.

5. The lid opening and closing device according to claim 3, wherein;
the diameter of the first sleeve is set smaller than the diameter of the second sleeve,
the insertion groove penetrates the connecting main body portion in the radial direction of the sleeve, and,
the first leg portion and the insertion groove are arranged so as to overlap each other, when viewed from the axial direction of the sleeve.
